(19) United States
(12) Patent Application Publication
(10) Pub. No.: US 2025/0306652 A1
(43) Pub. Date: Oct. 2, 2025

(54) PERFORMANCE, ACOUSTICS, AND TEMPERATURE CONTROL OF A COMPUTING SYSTEM

(71) Applicant: NVIDIA Corporation, Santa Clara, CA (US)

(72) Inventors: Nishanth BALASUBRAMANIAN, San Jose, CA (US); Sau Yan Keith LI, San Jose, CA (US); Thomas E. DEWEY, Menlo Park, CA (US); Michael IRWIN, Menlo Park, CA (US); Brady P. STRABEL, Santa Clara, CA (US)

(21) Appl. No.: 19/078,025

(22) Filed: Mar. 12, 2025

Related U.S. Application Data
(60) Provisional application No. 63/570,524, filed on Mar. 27, 2024.

(51) Int. Cl. G06F 1/20

(52) U.S. Cl. CPC G06F 1/20

(57) ABSTRACT

Various embodiments include techniques for controlling temperature and fan speed in a computing system. Conventional computing systems present the user with a very limited set of three or four curated performance mode presets, which can impose substantial trade-offs in performance, acoustic noise, and/or case temperature that the user may find to be unacceptable. By contrast, the disclosed techniques allow the user to precisely position the operation of the computing system anywhere in the two-dimensional space of fan speed (which determines acoustic noise) versus case temperature that suits the preference of the user. The disclosed techniques further provide a closed-loop feedback control system for controlling the case temperature. This closed-loop feedback control system operates in conjunction with the adjustable case temperature target to determine individual power limits for certain components, such as a CPU power limit, a GPU power limit, and/or the like.

### CROSS-REFERENCE TO RELATED APPLICATIONS

This application claims the benefit of the co-pending United States Provisional Patent Application titled, “PERFORMANCE, ACOUSTICS, AND TEMPERATURE CONTROL OF A COMPUTING DEVICE,” filed on Mar. 27, 2024, and having Ser. No. 63/570,524. The subject matter of this related application is hereby incorporated herein by reference.

### BACKGROUND

### Field of the Various Embodiments

Various embodiments relate generally to computer system architectures and, more specifically, to performance, acoustics, and temperature control of a computing system.

### Description of the Related Art

A computing system generally includes various components, such as, among other things, one or more processing units, such as central processing units (CPUs) and/or graphics processing units (GPUs), one or more memory systems, and other devices. During operation, these devices can generate heat that can cause temperature increases of components, of the air within the computing system, and, by extension, the temperature of the enclosure that contains the computing system. This enclosure can be a case, a skin, or any other suitable enclosure. Such an increase in case temperature (casetemp), also referred to as skin temperature (skintemp), can be especially problematic for computing systems that routinely come into direct contact with the user, such as laptops, tablet computers, mobile phones, and/or the like. In general, higher performance levels of the computing system can lead to higher power consumption, resulting in higher casetemps. Under extreme conditions, the casetemp can increase significantly, which can cause discomfort to a user who comes into contact with the enclosure.

To mitigate such increases in casetemp, a computing system typically includes a cooling device, such as a fan, to transfer heat from the ambient air within the enclosure to the air outside of the computing system. The fan can operate at different fan speeds, depending on the desired level of air movement and, by extension, the desired amount of cooling. Typically, these computing systems operate over a very limited set of curated user-selectable performance mode (perfmode) settings that allow the user to restrict power consumption, and therefore performance of the device, in the expectation that restricting power consumption can result in both cooler casetemps and lower fan speeds. Lower fan speeds can be desirable to reduce the acoustic noise generated by the fan and, correspondingly, the acoustic noise generated by the computing system. In some systems, lower perfmodes settings that restrict power consumption and reduce fan speed can result in reduced acoustic noise but with warmer casetemps, rather than cooler casetemps, relative to higher perfmode settings. Whether lower perfmode settings result in cooler casetemps or warmer casetemps can depend on the relative increase in thermal resistance from the lower RPMs of the fan speed crossed with the relative decrease in power consumption.

Underlying these perfmodes is a set of one or more “fan tables” where the entries of the fan table can be used to set the fan speed in proportion to one or more processor temperatures of the computing device. In general, these fan tables are highly quantized, with typically no more than three or four fixed values between the lowest and the highest fan speeds. Conventionally, the computing system can select a preset from among a limited set of presets corresponding to processor-level and/or platform/device-level power limits. Conventionally, a change in power consumption can result in a change in junction temperature (Tj) of one or more components, which, in turn, can cause a change in fan RPM based on the entries of the fan table. In one example, a computing system can select a preset from among three presets: (1) a “performance” preset corresponding to a high power limit, a high fan speed, and a high casetemp; (2) a “balanced” preset corresponding to a medium power limit, a medium fan speed, and a medium casetemp; and (3) a “quiet” preset corresponding to a low power limit, a low fan speed and a low casetemp.

This technique of selecting a perfmode from a limited number of presets can pose several problems. First, by presenting a limited number of perfmode presets, the user can generally select between warm and noisy operation (performance perfmode), cool and quiet operation (quiet perfmode), or an average of these two modes (balanced perfmode). The user cannot select other modes which may be desirable, such as warm and quiet operation or cool and loud operation. These alterative operating modes, if available, could offer higher performance than the cool and quiet operating perfmode, at the cost of either higher casetemp or higher fan speeds (resulting in higher acoustic noise). However, existing computing systems do not offer these alternative operating modes. The limited set of available perfmodes can impose substantial trade-offs in performance, acoustics, or casetemp selections that users can find to be unacceptable. Further, by limiting operation to a small number of presets, the user has only a very coarse level of control over case temp and acoustic noise caused by the fan. In addition, when the components are performing at a high level for a period of time, such as when executing a software application with a computing workload and/or processing workload, component temperature and/or ambient temperature can fluctuate. Such temperature fluctuations can cause the casetemp and fan speed (that is, acoustic noise) to stray from steady state conditions. Under such conditions, the casetemp and/or fan speed can be higher than the intended levels that would be expected under more typical conditions. Further, when switching between two presets in the fan table, the fan speed can suddenly change between the one preset fan speed and another preset fan speed, which can cause a corresponding sudden change in the acoustic noise level generated by the fan. Therefore, if the temperature fluctuates enough to cause these transient fan speed fluctuations, the resulting sudden change in acoustic noise level can be jarring and/or annoying to the user.

As the foregoing illustrates, what is needed in the art are more effective techniques for controlling temperature and fan speed in a computing system.

### SUMMARY

Various embodiments of the present disclosure set forth a computer-implemented method for controlling temperature and fan speed in a computing system. The method includes determining a power limit based on a power delivery capability of the computing system. The method further includes determining a first fan speed limit based on a target acoustic level. The method further includes determining a first temperature target based on a target case temperature. The method further includes identifying a first region within a two-dimensional space of fan speed versus case temperature based on at least one of the power limit, the first fan speed limit, or the first temperature target. The method further includes setting a first operational performance mode of the computing system that corresponds to the first region within the two-dimensional space.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, the computing system is not restricted to a very limited set of perfmodes. Instead, the user interface executing on the computing system can provide input controls to allow the user to fully customize the operation of the computing system by trading among performance, acoustics, and casetemp, depending on the needs of the user. In addition, in some embodiments, the fan speed limit can be violated if the current case temperature (casetemp) exceeds, or is substantially close to, a threshold temperature, such as a critical temperature and/or an unsafe temperature, thereby reducing the likelihood of overheating.

Another technical advantage of the disclosed techniques is that, with the disclosed techniques, the computing system includes an adjustable fan speed limit and a closed-loop feedback casetemp controller with a corresponding adjustable casetemp limit for more precise control of actual casetemp. With a more precise control of actual casetemp, the computing system can operate with higher performance in a given perfmode, relative to conventional techniques. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 illustrates a graph of operating conditions of the computing system of FIGS. 1-3, according to various embodiments;

FIGS. 5A-5B set forth a block diagram of a platform thermal acoustic control (PTAC) system included in the computing system of FIGS. 1-4, according to various embodiments;

FIGS. 6A-6B illustrate graphs of operating conditions of various applications executing on the computing system of FIGS. 1-5, according to various embodiments; and

FIG. 7 is a flow diagram of method steps for controlling operating conditions in the computing system of FIGS. 1-6B, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

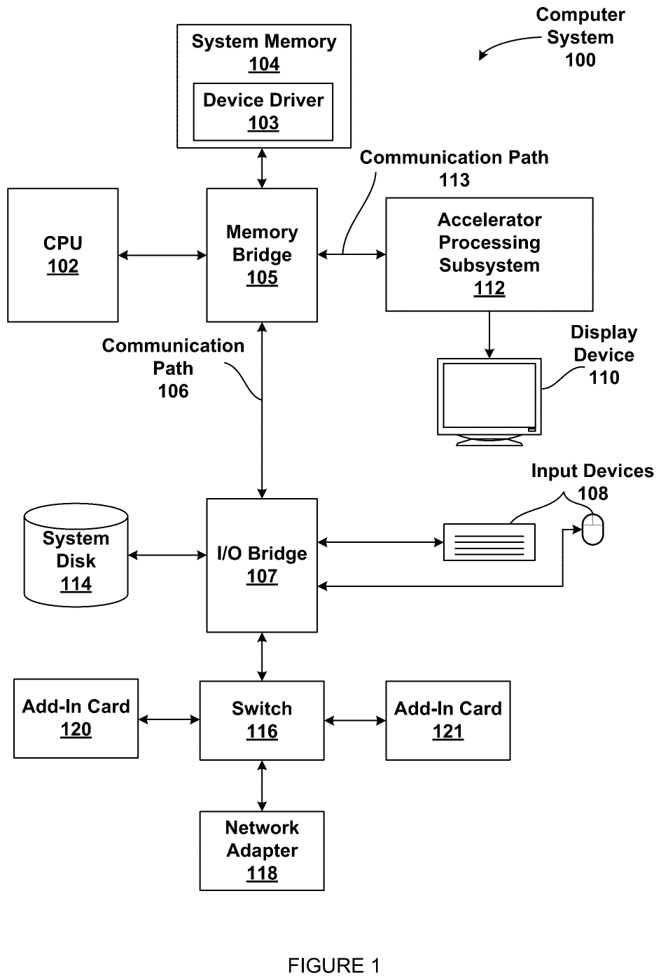

FIG. 1 is a block diagram of a computing system 100 configured to implement one or more aspects of the various embodiments. As shown, computing system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

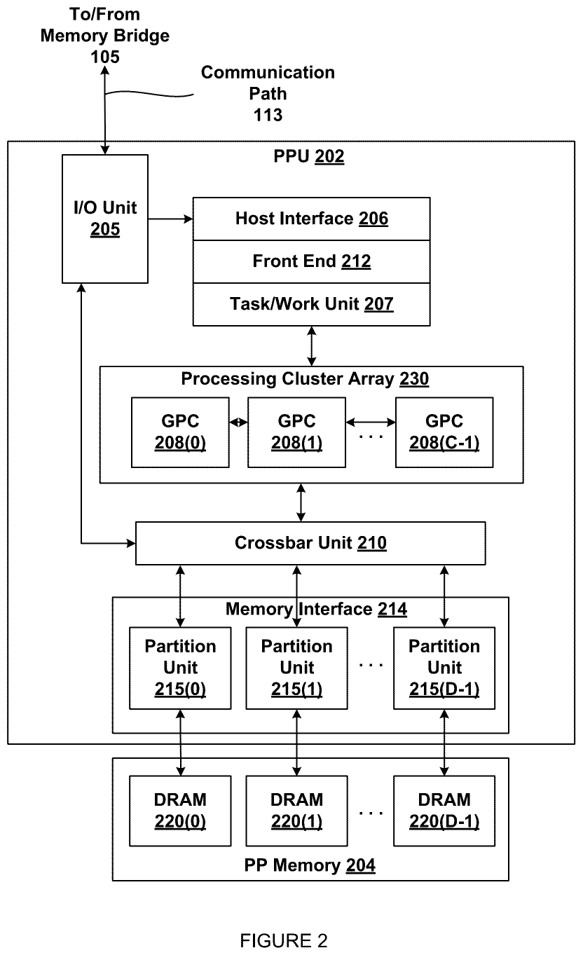

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural accelerator unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, accelerator processing subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of accelerators disclosed herein, in any technically feasible combination. The secondary processor receives secure commands from the primary processor via a communication path that is not secured. The secondary processor accesses a memory and/or other storage system, such as such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more other the other elements of FIG. 1 to form a single system. For example, accelerator processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, DMA units, IPUs, NAUs, TPUs, NNPs, DPUs, VPUs, ASICs, FPGAs, and/or the like. The techniques disclosed in FIGS. 2-4 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or accelerators other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, accelerator processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computing system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

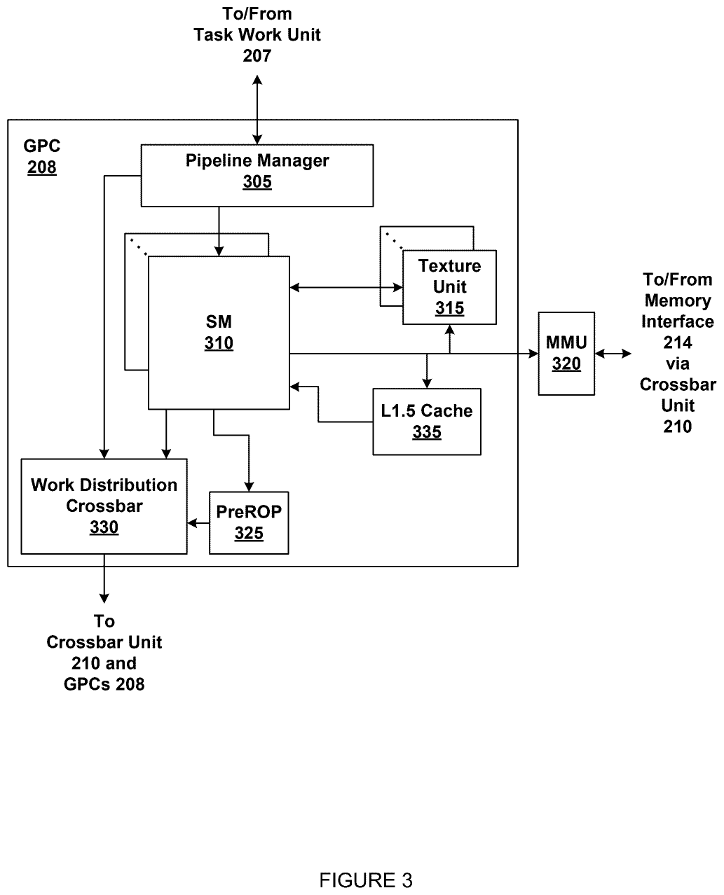

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches.

### Performance, Acoustics, and Temperature Control of a Computing System

Various embodiments include techniques for controlling temperature and fan speed in a computing system. As described herein, conventional computing systems present the user with a very limited set of three or four curated perfmode presets, which can impose substantial trade-offs in performance, acoustic noise, and/or casetemp that the user may find to be unacceptable. By contrast, the disclosed techniques allow the user to precisely position the operation of the computing system anywhere in the two-dimensional space (two-space) of fan speed (acoustic noise) versus casetemp that suits the preference of the user. As a result, the user can select a perfmode within a wide range of the two-space rather than being restricted to a small number of perfmode presets. The techniques include controls for adjustable fan speed limit based on the selected perfmode and a closed-loop feedback control system for casetemp, with a corresponding adjustable casetemp limit.

The disclosed techniques further provide a closed-loop feedback control system for controlling the casetemp. This closed-loop feedback control system operates in conjunction with the adjustable casetemp limit to determine individual power limits for certain components, such as a CPU power limit, a GPU power limit, and/or the like. The temperature sensors can be placed on various parts of the platform/device, including on the computing system motherboard, to determine more precise measurement of actual casetemp. In some embodiments, one or more component temperatures, such as CPU temperature, GPU temperature, and/or the like, can be used as a proxy for casetemp. Such components may include an internal temperature sensor that can be accessed by the computing system, thereby reducing the need to add temperature sensors to directly measure casetemp. When such casetemp proxies are employed, the computing system can apply a guard-band to the temperature measurement to account for the potential difference and inaccuracy between component temperature and casetemp. This guard-band approach can reduce the cost of adding temperature sensors to the computing system, as balanced against a potential reduction in casetemp measurement accuracy, which can potentially reduce the maximum achievable performance in a given perfmode.

In operation, a processor, such as CPU 102, PPU 202, a microcontroller, and/or the like, sets processor and/or platform/device power limits as high as practicable, within power delivery capabilities of computing system 100 and based on a power delivery capability of the computing system. The processor sets a fan speed limit for one or more variable speed fans and/or other cooling devices, based on a desired target acoustic level. The processor sets a casetemp target, based on a desired target case temperature. In operation, the casetemp control system actuates the power source for one or more devices. The casetemp control system sets the power level below the absolute power limits of the one or more devices. These absolute power limits are set in accordance with the power delivery capabilities. The fan speed is set independently by the fan controller as a function of the corresponding junction temperature of the one or more devices. In some embodiments, the power limit of the one or more devices is sufficiently high such that the junction temperature can rise to a temperature that would otherwise cause the controller to set the fan speeds to exceed the fan speed limit. By contrast, with the disclosed techniques, the fan speed is held constant at the fan speed limit, and not allowed to exceed the fan speed limit, resulting in the desired acoustic level. The casetemp control system adjusts the power of the one or more devices to yield maximum performance, subject to the casetemp limit and/or target, while the fan speed is expected to remain constant at the target fan speed limit.

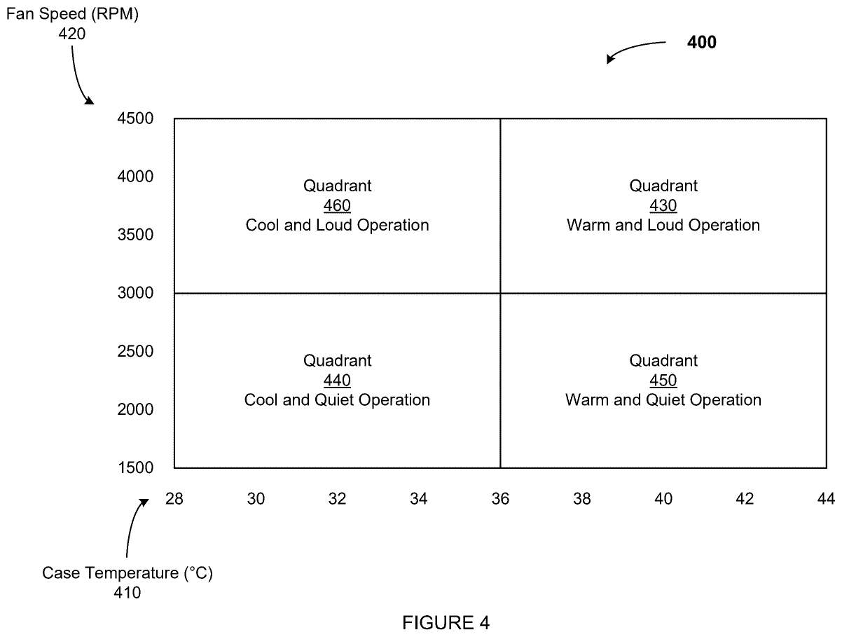

Via these steps, as shown in FIG. 4, the processor can maintain the operation of computing system 100 across a multiplicity of perfmodes that can be defined across the entire two-space of acoustics and casetemp, rather than being limited to a small number of preset perfmodes. In that regard, FIG. 4 illustrates a graph 400 of operating conditions of the computing system 100 of FIGS. 1-3, according to various embodiments. This two-space illustrated in graph 400 can be defined by the relationship between fan speed 420 in revolutions per minute (RPM) and case temperature 410 in degrees Celsius (° C.). Stated another way, the controller can maintain the operation of computing system 100 in all four quadrants of the two-space. These four quadrants include: (1) a quadrant 430 representing warm and loud operation; (2) a quadrant 440 representing cool and quiet operation; (3) a quadrant 450 representing warm and quiet operation; and/or (4) a quadrant 460 representing cool and loud operation. In addition, by explicitly setting a fan speed limit and casetemp target, the processor included in computing system 100 can provide more precise control of acoustics and casetemp, regardless of fluctuations in ambient temperature or workload-based geographic power distribution. Further, in some embodiments, the processor and the closed-loop feedback control system can adapt to variances resulting from manufacturing tolerance of the components included in the closed-loop feedback control system itself. By contrast, conventional power-limit based systems are not able to adapt to such manufacturing variances.

Further, via the processor included in computing system 100, the user can be afforded independent control of the acoustic and casetemp targets. Depending on the user interface controls provided by computing system 100, a user can select from among a large number of preset perfmodes. As a result, the user can control the perfmode, and, by extension, the performance, fan speed, and casetemp, with as much precision as the user interface software executing on computing system 100 is configured to provide.

As a result, rather than being restricted to a small number of preset perfmodes, the user can customize operating conditions with respect to performance, acoustics, and casetemp. In addition, the computing system can select a steeper fan table curve in the fan speed (acoustic noise) versus casetemp two-space, resulting in access to a greater portion of the cool and noisy operating space, while still maintaining operation at or below the selected fan speed limit and/or casetemp target.

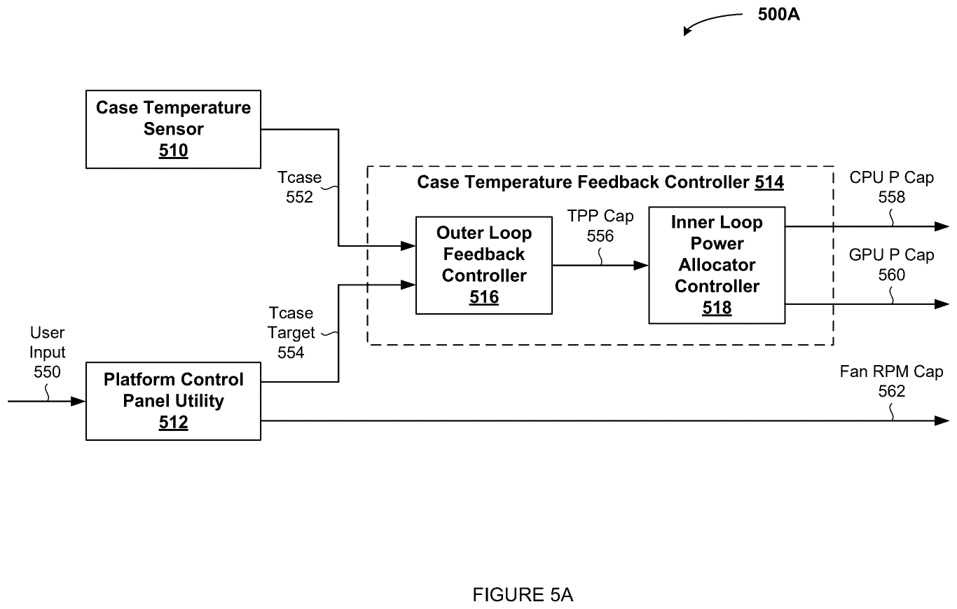

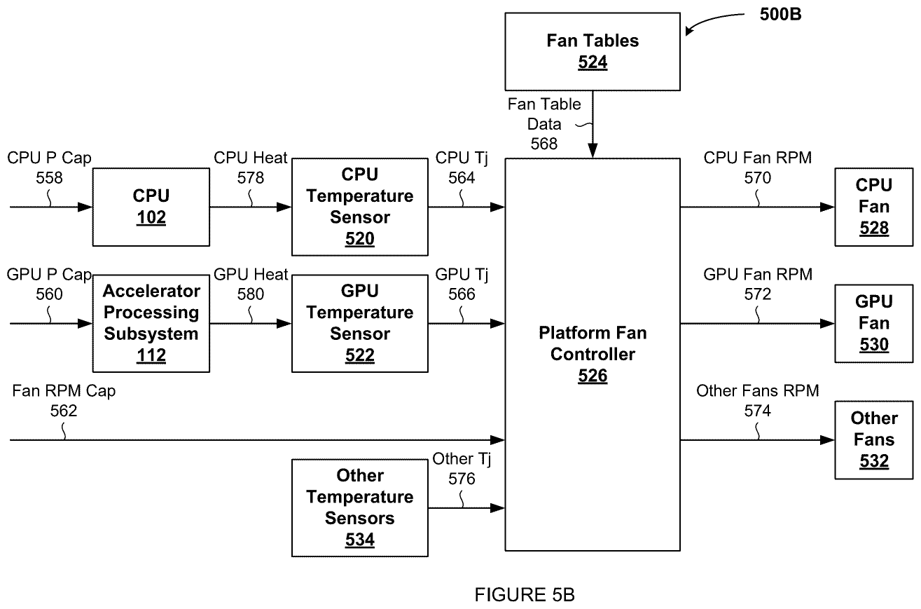

FIGS. 5A-5B set forth a block diagram of a platform thermal acoustic control (PTAC) system 500A and 500B, hereinafter 500, included in the computing system 100 of FIGS. 1-4, according to various embodiments. As shown, PTAC system 500 includes, without limitation, a platform control panel utility 512, a case temperature feedback controller 514, fan tables 524, a platform fan controller 526, a CPU fan 528, a GPU fan 530, as well as other fans 532. Further, PTAC system 500 includes, without limitation, a CPU temperature sensor 520, a GPU temperature sensor 522, a case temperature sensor 510, as well as other temperature sensors 534. Case temperature feedback controller 514 includes, without limitation, an outer loop feedback controller 516 and an inner loop power allocator controller 518. Various units of PTAC system 500 communicate with each other via various interconnects, described herein. These interconnects can include any suitable connection bus, mesh, network, point-to-point connections, and/or the like, in any combination, for transmitting and receiving data between and among these units of PTAC system 500.

Various components of PTAC system 500, including, without limitation, case temperature feedback controller 514 and platform fan controller 526 can include any of one or more processors that can execute instructions including, without limitation, a microcontroller, a RISC processor, a CPU, a PPU, a GPU, a DMA unit, an IPU, an NAU, a TPU, a NNP, a DPU, a VPU, an ASIC, an FPGA, and/or the like. Such components can include memory to store instructions that can the components to perform various operations described herein. Such components can further include memory for storing data associated with those operations. In that regard, CPU 102, accelerator processing subsystem 112, and/or the like can store instructions and/or data in the memory of the components through memory bridge 105 via communication path 113. Similarly, the components can communicate with memory bridge 105 via communication path 113. Through memory bridge 105, the components can communicate with various other units and/or components of computing system 100.

Further, the components can communicate with various units and/or components of PTAC system 500. The components can configure and/or control operation of these units and/or components of PTAC system 500, including various operations to control the operational parameters of computing system 100. The components can receive data from the units and/or components of PTAC system 500 resulting from performing these various operations.

Case temperature sensor 510 represents one or more temperature sensors mounted on or near the case, and/or other enclosure, of computing system 100. Case temperature sensor 510 can measure a temperature on the surface of the enclosure of computing system 100, a temperature of a component that is in contact with the enclosure of computing system 100, an ambient temperature of the environment near the enclosure of computing system 100, and/or the like. Outer loop feedback controller 516 included in case temperature feedback controller 514 can utilize the signal(s) received from case temperature sensor 510 to directly measure the temperature of the enclosure of computing system 100 based on the temperature received from case temperature sensor 510.

Platform control panel utility 512 executes on one or more processors included in computing system 100, such as CPU 102. Platform control panel utility 512 receives user input 550 regarding a selected perfmode, including a selected maximum operation temperature and a selected maximum acoustic level. Based on the user input 550, platform control panel utility 512 determines a target case temperature (Tcase target) 554 and a fan speed limit (fan RPM cap) 562. Platform control panel utility 512 transmits target case temperature 554 to outer loop feedback controller 516. Platform control panel utility 512 transmits fan speed limit 562 to platform fan controller 526.

As shown, outer loop feedback controller 516 receives case temperature (Tcase) 552 from one or more case temperature sensors, such as case temperature sensor 510. Case temperature sensor 510 represents one or more temperature sensors mounted on or near the case, and/or other enclosure, of computing system 100. Case temperature sensor 510 can measure a temperature on the surface of the enclosure of computing system 100, a temperature of a component that is in contact with the enclosure of computing system 100, an ambient temperature of the environment near the enclosure of computing system 100, and/or the like. Outer loop feedback controller 516 can utilize the signal(s) received from case temperature sensor 510 to directly measure the temperature of the enclosure of computing system 100 based on the temperature received from case temperature sensor 510.

Additionally or alternatively, outer loop feedback controller 516 can receive temperature data from one or more other temperature sensors, such as ambient temperature sensors, junction temperature sensors associated with specific components, package temperature sensors associated with specific components, and/or the like. Temperature data from these other temperatures can serve as proxies for the case temperature. In that regard, outer loop feedback controller 516 can determine the case temperature directly from case temperature sensor 510 and/or indirectly by applying a function to temperature data received from other temperature sensors.

Further, outer loop feedback controller 516 receives target case temperature 554 from platform control panel utility 512. Based on the difference between case temperature 552 and target case temperature 554, outer loop feedback controller 516 determines a temperature error. Based on this temperature error, outer loop feedback controller 516 determines a total processing power limit (TPP cap) 556. Outer loop feedback controller 516 transmits total processing power limit 556 to inner loop power allocator controller 518 included in case temperature feedback controller 514.

Inner loop power allocator controller 518 receives total processing power limit 556 from outer loop feedback controller 516. Based on total processing power limit 556 determines individual power limits for certain components, including, without limitation, a CPU power limit (CPU P cap) 558 for CPU 102, a GPU power limit (GPU P cap) 560 for accelerator processing subsystem 112, and/or the like. Inner loop power allocator controller 518 transmits CPU power limit 558 to CPU 102 in order to limit the component power on the load side of CPU 102 by adjusting the operating voltage and frequency of CPU 102 such that the power consumed by CPU 102, when executing the present workload, does not exceed the set CPU power limit 558. Similarly, inner loop power allocator controller 518 transmits GPU power limit 560 to accelerator processing subsystem 112 in order to limit the component power on the load side of accelerator processing subsystem 112 by adjusting the operating voltage and frequency of accelerator processing subsystem 112 such that the power consumed by accelerator processing subsystem 112, when executing the present workload, does not exceed the set GPU power limit 560.

CPU heat 578 generated by CPU 102 can be based on the workload being executed by CPU 102, the power supplied to CPU 102 (as limited by CPU power limit 558), and/or the like. Limiting the operating voltage and frequency supplied to CPU 102, in turn, limits the power consumption of CPU 102 and, by extension, the operating temperature of CPU 102. The operating temperature of CPU 102, in turn, impacts the CPU heat 578 generated by CPU 102. CPU temperature sensor 520 detects the CPU heat 578 generated by CPU 102 and generates a corresponding CPU junction temperature (CPU Tj) 564, as described herein.

Similarly, GPU heat 580 generated by accelerator processing subsystem 112 can be based on the workload being executed by accelerator processing subsystem 112, the power supplied to accelerator processing subsystem 112 (as limited by GPU power limit 560), and/or the like. Limiting the operating voltage and frequency supplied to accelerator processing subsystem 112, in turn, limits the power consumption of accelerator processing subsystem 112 and, by extension, the operating temperature of accelerator processing subsystem 112. The operating temperature of accelerator processing subsystem 112, in turn, impacts the GPU heat 580 generated by accelerator processing subsystem 112. GPU temperature sensor 522 detects the GPU heat 580 generated by accelerator processing subsystem 112 and generates a corresponding GPU junction temperature (GPU Tj) 566, as described herein.

In normal operation, the power limits generated by case temperature feedback controller 514, such as total processing power limit 556, CPU power limit 558, GPU power limit 560, and/or the like, are expected to be below the maximum power limits of computing system 100. In some embodiments, the platform power limit, such as total processing power limit 556, and electronic component power limits, such as CPU power limit 558 and GPU power limit 560, act as clamps on the output of the outer loop feedback controller 516 and the output of inner loop power allocator controller 518. Typically, these maximum power levels are not adjustable or unique on a per perfmode basis. Instead, these maximum power levels can be fixed, based on the associated power delivery components. These maximum power levels can act as a governor on outer loop feedback controller 516 and inner loop power allocator controller 518 to prevent PTAC system 500 from exceeding the platform power delivery capabilities of computing system 100. Therefore, these maximum power levels would not be adjustable by, or visible to, the end user who provides user input 550 via platform control panel utility 512.

CPU temperature sensor 520 represents one or more CPU temperature sensors that can be mounted on or near CPU 102. In some embodiments, CPU temperature sensor 520 can be mounted to the motherboard or other printed circuit board to which CPU 102 is mounted. CPU temperature sensor 520 can measure a junction temperature and/or other device temperature on the surface of the integrated circuit that contains CPU 102, a package temperature of an assembly that contains CPU 102, an ambient temperature of the environment near CPU 102, and/or the like. Based on such measurements, CPU temperature sensor 520 generates a CPU junction temperature (CPU Tj) 564 and transmits the CPU junction temperature 564 to platform fan controller 526.

GPU temperature sensor 522 represents one or more GPU temperature sensors that can be mounted on or near accelerator processing subsystem 112. In some embodiments, GPU temperature sensor 522 can be mounted to the motherboard or other printed circuit board to which accelerator processing subsystem 112 is mounted. GPU temperature sensor 522 can measure a junction temperature and/or other device temperature on the surface of the integrated circuit that contains accelerator processing subsystem 112, a package temperature of an assembly that contains accelerator processing subsystem 112, an ambient temperature of the environment near accelerator processing subsystem 112, and/or the like. Based on such measurements, GPU temperature sensor 522 generates a GPU junction temperature (GPU Tj) 566 and transmits the CPU junction temperature 564 to platform fan controller 526.

Platform fan controller 526 can utilize the signal(s), such as CPU junction temperature 564, received from CPU temperature sensor 520 to measure the operating temperature of CPU 102. Further, platform fan controller 526 can utilize the signal(s) received from CPU temperature sensor 520 to indirectly measure the temperature of CPU 102. Platform fan controller 526 can apply one or more correction factors to adjust CPU junction temperature 564 received from CPU temperature sensor 520. Platform fan controller 526 applies these correction factors to determine a proxy temperature of CPU 102 based on the temperature signals received from CPU temperature sensor 520. Whether platform fan controller 526 determines the temperature of CPU 102 through direct measurement and/or indirect measurement, platform fan controller 526 selects an entry in fan tables 524 that includes fan table data 568. Fan table data 568 maps a series of junction temperature thresholds to corresponding quantized fan speed values, where a higher junction temperature maps to a higher fan speed value. Platform fan controller 526 selects the entry based on CPU junction temperature 564. More particularly, platform fan controller 526 selects an entry in fan tables 524, where the entry includes a temperature that matches or is substantially similar to the CPU temperature as determined by platform fan controller 526. Platform fan controller 526 retrieves fan table data 568 corresponding to the entry from fan tables 524. Fan table data 568 maps the temperature to a corresponding fan speed. Platform fan controller 526 generates a CPU fan speed 570 based on the corresponding fan speed, subject to fan speed limit 562 received from platform control panel utility 512. In some embodiments, platform fan controller 526 generates CPU fan speed 570 as a pulse width modulated (PWM) signal that determines the speed of CPU fan 528. By limiting CPU fan speed 570, platform fan controller 526 maintains CPU fan speed 570 at or below fan speed limit 562, even if fan table data 568 indicates a higher fan speed. Platform fan controller 526 can thereby limit the acoustic noise generated by CPU fan 528.

Similarly, platform fan controller 526 can utilize the signal(s), such as GPU junction temperature 566, received from GPU temperature sensor 522 to measure the operating temperature of accelerator processing subsystem 112. Further, platform fan controller 526 can utilize the signal(s) received from GPU temperature sensor 522 to indirectly measure the temperature of accelerator processing subsystem 112. Platform fan controller 526 can apply one or more correction factors to adjust GPU junction temperature 566 received from GPU temperature sensor 522. Platform fan controller 526 applies these correction factors to determine a proxy temperature of accelerator processing subsystem 112 based on the temperature signals received from GPU temperature sensor 522. Whether platform fan controller 526 determines the temperature of accelerator processing subsystem 112 through direct measurement and/or indirect measurement, platform fan controller 526 selects an entry in fan tables 524 that includes fan table data 568. Platform fan controller 526 selects the entry based on GPU junction temperature 566. More particularly, platform fan controller 526 selects an entry in fan tables 524, where the entry includes a temperature that matches or is substantially similar to the GPU temperature as determined by platform fan controller 526. Platform fan controller 526 retrieves fan table data 568 corresponding to the entry from fan tables 524. Fan table data 568 maps the temperature to a corresponding fan speed. Platform fan controller 526 generates a GPU fan speed 572 based on the corresponding fan speed, subject to fan speed limit 562 received from platform control panel utility 512. In some embodiments, platform fan controller 526 generates GPU fan speed 572 as a PWM signal that determines the speed of GPU fan 530. By limiting GPU fan speed 572, platform fan controller 526 maintains GPU fan speed 572 at or below fan speed limit 562, even if fan table data 568 indicates a higher fan speed. Platform fan controller 526 can thereby limit the acoustic noise generated by GPU fan 530.

In some embodiments, platform fan controller 526 generates other fans speed (other fans RPM) 574 for other fans 532. Platform fan controller 526 can determine a temperature corresponding to other fans 532 based on CPU junction temperature 564 received from CPU temperature sensor 520, GPU junction temperature 566 received from GPU temperature sensor 522, temperature data from other temperature sensors 534, and/or the like. Platform fan controller 526 selects an entry in fan tables 524 that includes fan table data 568. Platform fan controller 526 selects the entry based on the temperature corresponding to other fans 532. More particularly, platform fan controller 526 selects an entry in fan tables 524, where the entry includes a temperature that matches or is substantially similar to the temperature corresponding to other fans 532 as determined by platform fan controller 526. Platform fan controller 526 retrieves fan table data 568 corresponding to the entry from fan tables 524. Fan table data 568 maps the temperature to a corresponding fan speed. Platform fan controller 526 generates other fans speed 574 for other fans 532 based on the corresponding fan speed, subject to fan speed limit 562 received from platform control panel utility 512. In some embodiments, platform fan controller 526 generates other fans speed 574 as a PWM signal that determines the speed of other fans 532. By limiting other fans speed 574, platform fan controller 526 maintains other fans speed 574 at or below fan speed limit 562, even if fan table data 568 indicates a higher fan speed. Platform fan controller 526 can thereby limit the acoustic noise generated by other fans 532.

Other temperature sensors 534 can include temperature sensors mounted directly to and/or near other components of computing system 100, near air inlets and/or air outlets of computing system 100, and/or at any suitable location within the enclosure of computing system 100. In some embodiments, other temperature sensors 534 can be mounted to the motherboard and/or other printed circuit boards to which various components of computing system 100 are mounted. Other temperature sensors 534 can measure other junction temperatures (other Tj) 576 and/or other device temperatures on the surface of the one or more integrated circuits in computing system 100, a package temperature of an assembly included in computing system 100, an ambient temperature of the environment of a region within computing system 100, and/or the like. PTAC system 500 can utilize the other junction temperatures 576 and/or other device temperature signal(s) received from other temperature sensors 534 to measure the operating temperature of components and/or regions within computing system 100. Further, PTAC system 500 can utilize the other junction temperatures 576 and/or other device temperature signal(s) received from other temperature sensors 534 to indirectly measure the temperature of the enclosure of computing system 100. PTAC system 500 can apply one or more correction factors to adjust the other junction temperatures 576 and/or other device temperature(s) received from other temperature sensors 534. PTAC system 500 applies these correction factors to determine a proxy temperature of the enclosure of computing system 100 based on the other junction temperatures 576 and/or other device temperature(s) received from other temperature sensors 534.

In some embodiments, PTAC system 500 can combine the temperatures received from one or more of CPU temperature sensor 520, GPU temperature sensor 522, case temperature sensor 510, and/or other temperature sensors 534 to maintain the temperature of the enclosure of computing system 100 to less than or equal to the casetemp target. PTAC system 500 can utilize the temperature received from case temperature sensor 510 to directly measure the temperature of the enclosure of computing system 100. Additionally or alternatively, PTAC system 500 can utilize the temperature(s) received from one or more of CPU temperature sensor 520, GPU temperature sensor 522, and/or other temperature sensors 534 to indirectly measure the temperature of the enclosure of computing system 100. PTAC system 500 can apply one or more correction factors to adjust the temperature(s) received from one or more of CPU temperature sensor 520, GPU temperature sensor 522, and/or other temperature sensors 534. PTAC system 500 applies these correction factors to determine a proxy temperature of the enclosure of computing system 100 from the temperature(s) received from one or more of CPU temperature sensor 520, GPU temperature sensor 522, and/or other temperature sensors 534.

Such proxy temperatures can be less accurate than a direct measurement of the enclosure, as measured by case temperature sensor 510. To account for such reduced accuracy, PTAC system 500 can apply a guard band to artificially increase the proxy temperature(s) determined from temperatures measured by CPU temperature sensor 520, GPU temperature sensor 522, and/or other temperature sensors 534. This guard banding approach results in a more conservative proxy temperature, which can result in a reduction in the maximum performance level in a given performance mode, but has the benefit of reducing the likelihood of exceeding the casetemp target.

As described herein, PTAC system 500 can combine one or more of the temperatures from case temperature sensor 510 and/or corrected temperature(s) from one or more of CPU temperature sensor 520, GPU temperature sensor 522, and/or other temperature sensors 534 to determine a composite temperature for the enclosure of computing system 100. Based on this composite temperature, PTAC system 500 can set fan speeds for one or more of CPU fan 528, GPU fan 530, and/or other fans 532 to maintain the composite temperature at less than or equal to the casetemp target. Further, PTAC system 500 can utilize the temperatures received from one or more of CPU temperature sensor 520, GPU temperature sensor 522, case temperature sensor 510, and/or other temperature sensors 534 to individually maintain the operating temperatures of various components of computing system 100 at or below operating temperatures of these other components.

In operation, PTAC system 500 independently sets a processor and/or platform/device power limit, a fan speed limit, and a casetemp target for computing system 100. PTAC system 500 sets an operational performance mode (perfmode) by setting the processor and/or platform/device power limit, the fan speed limit, and the casetemp target. PTAC system 500 can receive one or more of the processor and/or platform/device power limit, the fan speed limit, and/or the casetemp target from a user via a user interface. Additionally or alternatively, PTAC system 500 can determine one or more of the processor and/or platform/device power limit, the fan speed limit, and/or the casetemp target based on various characteristics of computing system 100. Additionally or alternatively, PTAC system 500 can retrieve preset values for one or more of the processor and/or platform/device power limit, the fan speed limit, and/or the casetemp target from a memory included in computing system 100.

In addition, PTAC system 500 can independently determine a fan speed limit for each performance mode rather than being restricted to a limited set of entries in a conventional fan table that predetermines higher fan speed limits for higher processor temperatures and/or casetemp targets. In some embodiments, PTAC system 500 can set the fan speed limit based on the environment where computing system 100 is located. If computing system 100 is located in a quiet environment, such as a residential home, a business office, and/or the like, then a low acoustic noise from computing system 100 may be desirable. Accordingly, PTAC system 500 can set the fan speed limit to a relatively low limit. If computing system 100 is located in a noisy environment, such as a game room, an industrial workspace, and/or the like, then a high acoustic noise from computing system 100 may be acceptable. Accordingly, PTAC system 500 can set the fan speed limit to a relatively high limit.

In some embodiments, PTAC system 500 can set the casetemp target based on the surface upon which computing system 100 is placed. If computing system 100 is placed directly on the lap of a user, then a low temperature for computing system 100 may be desirable to avoid discomfort to the user. Accordingly, PTAC system 500 can set the casetemp target to a relatively low limit. If computing system 100 is placed on a temperature resistant surface, such as a desktop, a countertop, and/or the like, then a high temperature for computing system 100 may be acceptable. Accordingly, PTAC system 500 can set the casetemp target to a relatively high limit.

Further, PTAC system 500 can independently prioritize the processor and/or platform/device power limit, the fan speed limit, and/or the casetemp target with respect to each other and/or with respect to conventional fan tables. For example, PTAC system 500 can prioritize the fan speed limit set according to the techniques disclosed herein over a value from a predetermined conventional fan table.

In some embodiments, PTAC system 500 can override one or more of the preset processor and/or platform/device power limit, the fan speed limit, and/or the casetemp target. For example, PTAC system 500 can cause one or more of CPU fan 528, GPU fan 530, and/or other fans 532 to exceed the fan speed limit if the current case temperature of the enclosure of computing system 100 exceeds, or is substantially close to, a threshold temperature, such as the casetemp target, a critical temperature, an unsafe temperature, and/or the like. In such cases, PTAC system 500 can set the current fan speed to a speed that is greater than the fan speed target.

PTAC system 500 transmits signals to CPU fan 528, GPU fan 530, and/or other fans 532, in any combination, to adjust the air flow within computing system 100. In some embodiments, certain components, such as fan tables 524, platform fan controller 526, and/or the like, are included in the fan control system of computing system 100 and are not included in PTAC system 500. In such embodiments, fan tables 524 and platform fan controller 526 are independent from PTAC system 500. PTAC system 500 augments the components of the fan control system by introducing a fan speed limit. PTAC system 500 applies the fan speed limit to the existing fan control system in order to achieve a target fan speed, such as when computing system 100 is executing a demanding workload.

PTAC system 500 transmits a signal to CPU fan 528 to increase the fan speed and/or decrease the fan speed of CPU fan 528. CPU fan 528 can be a fan mounted directly to and/or near CPU 102. In some embodiments, CPU fan 528 can be mounted to the motherboard or other printed circuit board to which CPU 102 is mounted. In that regard, CPU fan 528 primarily cools CPU 102. Even so, in some embodiments, exhaust from CPU fan 528 can also cool other components of computing system 100, particularly components that are physically near to CPU 102. In some embodiments, CPU 102 is thermally connected to a heat-exchanger (such as cooling fins near the exhaust ports of CPU 102) using a heat-pipe. In such embodiments, CPU fan 528 blows air over the heat exchanger (and through the chassis to give some cooling benefit to other components, as noted).

CPU 102 can be configured to increase in performance, such as by increasing clock speed, performing more operations per unit of time, performing more complex operations, utilizing more subcomponents of CPU 102, and/or the like. As CPU 102 increases in performance, the power consumption and, correspondingly, the operating temperature of CPU 102 can also increase. This increase in power consumption and operating temperature can cause a relatively smaller increase in performance of CPU 102. This situation occurs because an increasing operating temperature of CPU 102 implies that a greater fraction of the core power is consumed by current/power leakage, such that the incremental power consumed in dynamic power is less than if the operating temperature had remained constant. In general, operating temperature of CPU 102 varies inversely with maximum performance of CPU 102. Further, in certain cases, power consumption and operating temperature can approach the maximum power consumption and/or maximum operating temperature of CPU 102. Exceeding the maximum power consumption and/or maximum operating temperature of CPU 102 can lead to undesirable operating conditions. Such undesirable operating conditions can include excessive wear of CPU 102, which can lead to shorter lifetime of CPU 102 and/or other damage modalities. Such undesirable operating conditions can further include non-damaging functional failures such as hardware timing failures of CPU 102, which can lead to data corruption, application program execution failure, and/or the like. Consequently, PTAC system 500 can increase the fan speed of CPU fan 528 to reduce the operating temperature of CPU 102 to avoid damage to CPU 102. In general, thermal-acoustic control systems adjust the power limit (that is, the power consumption) of the system components in order to comply with the casetemp target and/or the operating temperature target.

Further, PTAC system 500 adjusts the fan speed of CPU fan 528 within the selected fan speed limit and/or casetemp target. With respect to the selected fan speed limit, PTAC system 500 can adjust the fan speed of CPU fan 528 to restrict the fan speed to be less than or equal to the fan speed limit. In so doing, PTAC system 500 can allow the performance and/or operating temperature of CPU 102 to increase in order to maintain the fan speed of CPU fan 528 within the fan speed limit, thereby limiting acoustic noise from CPU fan 528. With respect to the selected casetemp target, PTAC system 500 can adjust the fan speed of CPU fan 528 to allow the fan speed to be greater than or equal to the fan speed needed to maintain the desired performance and/or operating temperature of CPU 102. More specifically, case temperature feedback controller 514 of PTAC system 500 works by actuating power of CPU 102 to zero out the temperature error between case temperature 552 and target case temperature 554, while the fan speed is assumed to be static at the chosen target. The objective of case temperature feedback controller 514 is to keep the case temperature 552 at or below the target case temperature 554.

Additionally and/or alternatively, PTAC system 500 transmits a signal to GPU fan 530 to increase the fan speed and/or decrease the fan speed of GPU fan 530. GPU fan 530 can be a fan mounted directly to and/or near accelerator processing subsystem 112. In some embodiments, GPU fan 530 can be mounted to the motherboard or other printed circuit board to which accelerator processing subsystem 112 is mounted. In that regard, GPU fan 530 primarily cools accelerator processing subsystem 112. Even so, in some embodiments, exhaust from GPU fan 530 can also cool other components of computing system 100, particularly components that are physically near to accelerator processing subsystem 112. In some embodiments, accelerator processing subsystem 112 is thermally connected to a heat-exchanger (such as cooling fins near the exhaust ports of accelerator processing subsystem 112) using a heat-pipe. In such embodiments, GPU fan 530 blows air over the heat exchanger (and through the chassis to give some cooling benefit to other components, as noted). Further, in some embodiments, the heat-pipes of CPU 102 and accelerator processing subsystem 112 are shared by thermally connecting CPU 102 and accelerator processing subsystem 112 together.

Accelerator processing subsystem 112 can be configured to increase in performance, such as by increasing clock speed, performing more operations per unit of time, performing more complex operations, utilizing more subcomponents of accelerator processing subsystem 112, and/or the like. As accelerator processing subsystem 112 increases in performance, the power consumption and, correspondingly, the operating temperature of accelerator processing subsystem 112 can also increase. This increase in power consumption and operating temperature can cause a relatively smaller increase in performance of accelerator processing subsystem 112. This situation occurs because an increasing operating temperature of accelerator processing subsystem 112 implies that a greater fraction of the core power is consumed by current/power leakage, such that the incremental power consumed in dynamic power is less than if the operating temperature had remained constant. In general, operating temperature of accelerator processing subsystem 112 varies inversely with maximum performance of accelerator processing subsystem 112. Further, in certain cases, power consumption and operating temperature can approach the maximum power consumption and/or maximum operating temperature of accelerator processing subsystem 112. Exceeding the maximum power consumption and/or maximum operating temperature of accelerator processing subsystem 112 accelerator processing subsystem 112 can lead to undesirable operating conditions. Such undesirable operating conditions can include excessive wear of accelerator processing subsystem 112, which can lead to shorter lifetime of accelerator processing subsystem 112 and/or other damage modalities. Such undesirable operating conditions can further include non-damaging functional failures such as hardware timing failures of accelerator processing subsystem 112, which can lead to data corruption, application program execution failure, and/or the like. Consequently, PTAC system 500 can increase the fan speed of GPU fan 530 to reduce the operating temperature of accelerator processing subsystem 112 to avoid damage to accelerator processing subsystem 112. Additionally and/or alternatively, PTAC system 500 can increase the fan speed of GPU fan 530 to allow accelerator processing subsystem 112 to increase in performance before the operating temperature reaches the maximum operating temperature.

Further, PTAC system 500 adjusts the fan speed of GPU fan 530 within the selected fan speed limit and/or casetemp target. With respect to the selected fan speed limit, PTAC system 500 can adjust the fan speed of GPU fan 530 to restrict the fan speed to be less than or equal to the fan speed limit. In so doing, PTAC system 500 can allow the performance and/or operating temperature of accelerator processing subsystem 112 to increase in order to maintain the fan speed of GPU fan 530 within the fan speed limit, thereby limiting acoustic noise from GPU fan 530. With respect to the selected casetemp target, PTAC system 500 can adjust the fan speed of GPU fan 530 to allow the fan speed to be greater than or equal to the fan speed needed to maintain the desired performance and/or operating temperature of accelerator processing subsystem 112. More specifically, case temperature feedback controller 514 of PTAC system 500 works by actuating power of accelerator processing subsystem 112 to zero out the temperature error between case temperature 552 and target case temperature 554, while the fan speed is assumed to be static at the chosen target. The objective of case temperature feedback controller 514 is to keep the case temperature 552 at or below the target case temperature 554.

Additionally and/or alternatively, PTAC system 500 transmits signals to other fans 532, in any combination, to adjust the air flow within computing system 100. PTAC system 500 transmits a signal to such other fans 532 to increase the fan speed and/or decrease the fan speeds of other fans 532. Other fans 532 can include fans mounted directly to and/or near other components of computing system 100, near air inlets and/or air outlets of computing system 100, and/or at any suitable location within the enclosure of computing system 100. In some embodiments, other fans 532 can be mounted to the motherboard and/or other printed circuit boards to which various components of computing system 100 are mounted. In that regard, other fans 532 can be configured to cool one or more specific components of computing system, to cool a particular region of computing system 100, to provide general cooling of computing system 100, and/or the like.

Further, PTAC system 500 adjusts the fan speed of other fans 532 within the selected fan speed limit and/or casetemp target. With respect to the selected fan speed limit, PTAC system 500 can adjust the fan speed(s) of other fans 532 to restrict the fan speed to be less than or equal to the fan speed limit. In so doing, PTAC system 500 can allow the performance and/or operating temperature of other fans 532 to increase in order to maintain the fan speed(s) of other fans 532 within the fan speed limit, thereby limiting acoustic noise from other fans 532. With respect to the selected casetemp target, PTAC system 500 can adjust the fan speed(s) of other fans 532 to allow the fan speed to be greater than or equal to the fan speed(s) needed to maintain the desired performance and/or operating temperature of other components of computing system 100.

In some embodiments, PTAC system 500 can combine the fan speeds of CPU fan 528, GPU fan 530, and/or other fans 532 to maintain the fan speeds within an overall fan speed limit, and thereby limit the overall acoustic noise generated by these fans. In so doing, PTAC system 500 can adjust the fan speeds of one or more of CPU fan 528, GPU fan 530, and/or other fans 532 to adequately cool the corresponding components, including CPU 102, accelerator processing subsystem 112, and/or other components and regions of computing system 100.

It will be appreciated that the system shown herein is illustrative and that variations and modifications are possible. In some embodiments, a conduit (not shown), such as a heat pipe, a heat exchanger, and/or the like, can connect the package that encloses CPU 102 with the package that encloses accelerator processing subsystem 112. This conduit can thermally couple CPU 102 and accelerator processing subsystem 112 in order to reduce the difference between the operating temperature of CPU 102 and/or the operating temperature of accelerator processing subsystem 112. As a result, either or both of CPU fan 528 and GPU fan 530 can cool either or both of CPU 102 and/or accelerator processing subsystem 112. In such embodiments, PTAC system 500 can determine the thermal coupling effect of the conduit between CPU 102 and accelerator processing subsystem 112 when determining the fan speeds of one or both of CPU fan 528 and GPU fan 530.

In general, the objective of PTAC system 500, and more specifically of case temperature feedback controller 514, is to drive the component power consumption as a high as possible without exceeding the casetemp target, and such that component junction temperatures are sufficiently high that platform fan controller 526 would otherwise set fan speeds that are above the fan speed limit that has been set for the corresponding performance mode. In so doing, case temperature feedback controller 514 attempts to “drive to the corner” of the fan speed and case temperature coordinate of the corresponding performance mode. In contrast, conventional systems result in operation that scatters operating conditions of various executing applications over a region of the fan speed and case temp two-space. The amount by which conventional systems cause applications executing on computing system 100 to operate below the target fan speed and/or the target case temperature, the applications execute with lower performance relative to the techniques described herein. In that regard, the disclosed PTAC system 500 operates to recover that missed performance opportunity by driving operation of computing system towards the corner of the fan speed and case temperature coordinate of the corresponding performance mode.

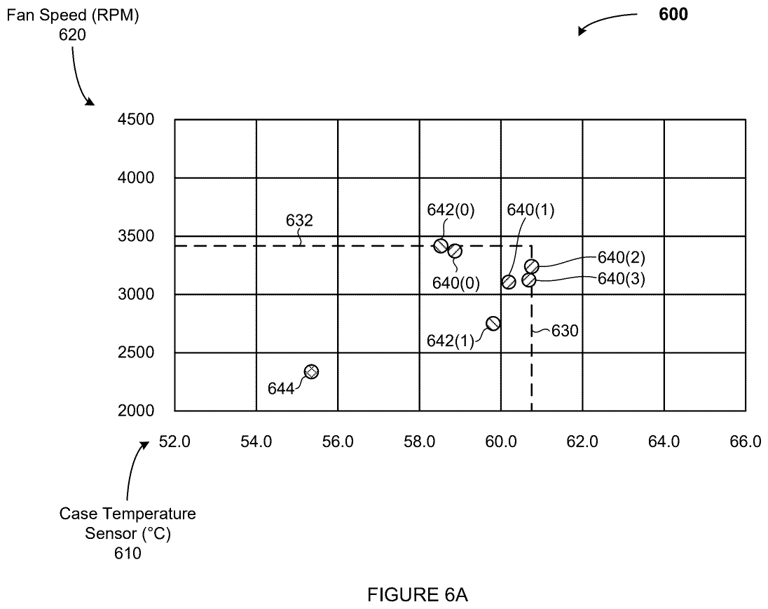

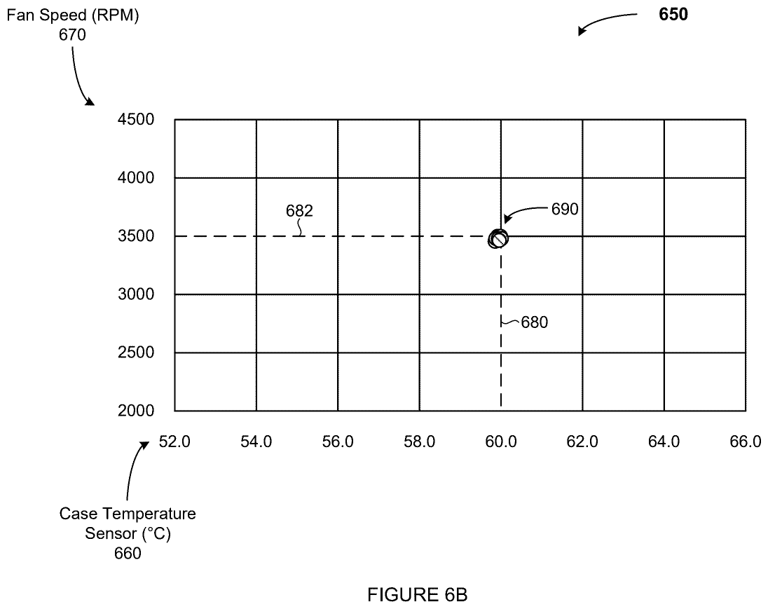

FIGS. 6A-6B illustrate graphs 600, 650 of operating conditions of various applications executing on the computing system 100 of FIGS. 1-5, according to various embodiments. As shown in FIG. 6A, graph 600 illustrates operating conditions of various applications executing on computing system 100 when case temperature feedback controller 514 of PTAC system 500 is disabled. Graph 600 is in the form of a scatter plot that represents the steady-state sensor readings of the fan speed 620 in revolutions per minute (RPM) and case temperature sensor readings 610 in degrees Celsius (° C.) across a selection of seven workloads. In some embodiments, the test measurements shown in graph 600 were taken on a laptop computer operating in an environment with an ambient temperature of approximately 22° C., referred to herein as room temperature. The seven workloads execute within a region defined by a maximum fan speed 632 of approximately 3450 RPM and a maximum case temperature sensor reading 630 of approximately 60.8° C. Note that graph 600 illustrates case temperature sensor readings 610, and not the actual case temperature as measured from a thermocouple. In some embodiments, the actual case temperature as measured from a thermocouple could be in range of the low 40s° C.

The seven workloads shown in graph 600 include four workloads 640(0)-640(3) representing gaming applications, two workloads 642(0)-642(1) representing thermal stress applications, and one workload 644 representing a creator application (such as a graphics rendering application). Gaming workload 640(0) operates at a fan speed 620 of approximately 3400 RPM and case temperature sensor reading 610 of approximately 58.8° C. Gaming workload 640(1) operates at a fan speed 620 of approximately 3100 RPM and case temperature sensor reading 610 of approximately 60.2° C. Gaming workload 640(2) operates at a fan speed 620 of approximately 3300 RPM and case temperature sensor reading 610 of approximately 60.8° C. Gaming workload 640(3) operates at a fan speed 620 of approximately 3100 RPM and case temperature sensor reading 610 of approximately 60.6° C. Thermal stress workload 642(0) operates at a fan speed 620 of approximately 3450 RPM and case temperature sensor reading 610 of approximately 58.6° C. Thermal stress workload 642(1) operates at a fan speed 620 of approximately 2750 RPM and case temperature sensor reading 610 of approximately 59.8° C. Creator workload 644 operates at a fan speed 620 of approximately 2400 RPM and case temperature sensor reading 610 of approximately 55.5° C.

Because case temperature feedback controller 514 of PTAC system 500 is disabled, the various workloads operate at various fan speeds 620 and case temperature sensor readings 610 that are typically less than the maximum fan speed 632 and the maximum case temperature sensor reading 630. A workload that operates at a fan speed 620 that is less than the maximum fan speed 632 can indicate that computing system 100 operating at a lower fan speed than necessary. By contrast, with PTAC system 500, a higher fan speed 632 would generally afford higher operating power, and higher resulting performance, of system components. As described in conjunction with FIG. 6B, PTAC system 500 drives to higher operating power until workloads reach operating conditions at the corner of the fan speed limit and target case temperature.

As shown in FIG. 6B, graph 650 illustrates operating conditions of various applications executing on computing system 100 when case temperature feedback controller 514 of PTAC system 500 is enabled. Graph 650 is in the form of a scatter plot that represents the steady-state sensor readings of the fan speed 670 in revolutions per minute (RPM) and case temperature sensor readings 660 in degrees Celsius (° C.) across a selection of seven workloads. In some embodiments, the test measurements shown in graph 650 were taken on a laptop computer operating in an environment with an ambient temperature of approximately 22° C., referred to herein as room temperature. As described in conjunction with graph 600 of FIG. 6A, graph 650 illustrates case temperature sensor readings 660, and not the actual case temperature as measured from a thermocouple. In some embodiments, the actual case temperature as measured from a thermocouple could be in range of the low 40s° C.

As shown, PTAC system 500 operates with a fan speed limit 682 of 3500 RPM and a target case temperature 680 of 60.0° C. In operation, PTAC system 500 increases fan speed when workloads are executing with a fan speed 670 that is less than the fan speed limit 682 of 3500 RPM. Further, case temperature feedback controller 514 of PTAC system 500 increases the power limit for one or more components when workloads are executing with a current case temperature sensor reading 660 that is less than the target case temperature 680. Similarly, case temperature feedback controller 514 of PTAC system 500 decreases the power limit for one or more components when workloads are executing with a current case temperature sensor reading 660 that is greater than the target case temperature 680. As a result, the operating conditions of all of the seven workloads will approach a fan speed 670 that is equal or substantially equal to the fan speed limit 682. Similarly, the operating conditions of all of the seven workloads will approach a current case temperature sensor reading 660 that is equal or substantially equal to the target case temperature 680. These operating conditions are reflected by workload cluster 690, showing that the operating conditions of all of the seven workloads are equal or substantially equal to a fan speed 670 of 3500 RPM and a current case temperature sensor reading 660 of 60.0° C.

As contrasted with the wide scatter in the fan speed 620 versus case temperature sensor reading 610 two-space for workloads executing when PTAC system 500 is disabled, as shown in graph 600, workloads executing when PTAC system 500 is enabled tend to tightly cluster at the fan speed limit 682 and the target case temperature 680, as shown in graph 650. As a result, computing system 100 operates at, or substantially at, the acoustic target and case temperature target selected by the user, with some precision, for all workloads and operating conditions. For workloads that would execute below these targets when PTAC system 500 is disabled, enabling PTAC system 500 causes case temperature feedback controller 514 to increase system power consumption higher to operate at the corner of the fan speed limit 682 and the target case temperature 680, which indicates higher performance. For workloads that would execute above these targets when PTAC system 500 is disabled, enabling PTAC system 500 causes case temperature feedback controller 514 to decrease system power consumption to operate at the corner of the fan speed limit 682 and the target case temperature 680, which tends to prevent or reduce operation above the target case temperature 680, albeit with some loss of performance.

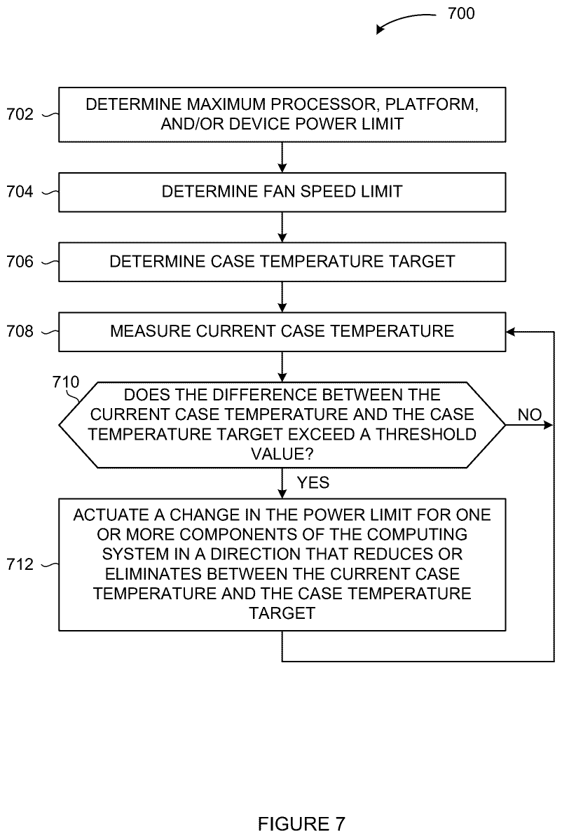

FIG. 7 is a flow diagram of method steps for controlling operating conditions in the computing system 100 of FIGS. 1-6B, according to various embodiments. Additionally and/or alternatively, the method steps can be performed by one or more alternative accelerators including, without limitation, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-6B, persons of ordinary skill in the art will understand that any system configured to perform the method steps, in any order, is within the scope of the present disclosure.

As shown, a method 700 begins at step 702, where a processor, such as PTAC system 500, determines the maximum processor, platform, and/or device power limit. The processor can determine the maximum processor and/or platform/device power limit based on various characteristics of computing system 100. Additionally and/or alternatively, the processor can retrieve preset values for the maximum processor and/or platform/device power limit from a memory included in computing system 100. The maximum processor and/or platform/device power limit can be determined based on whether the computing system 100 is operating on AC power or battery power, what types of software applications that computing system 100 is executing, and/or the like. The maximum processor and/or platform/device power limit can be set to a higher limit when computing system 100 is operating from AC power and can be set to a lower limit when computing system 100 is operating from battery power. In general, the maximum processor and/or platform/device power limit ‘is determined by the capability of the corresponding power source and is not adjusted based on workload demand. PTAC system 500 only uses these maximum processor and/or platform/device power limits so as not to command a power limit that is greater than what the power source can provide. In normal operation, thermal-acoustic constraints are more power restrictive than these maximum processor and/or platform/device power limits. Accordingly, case temperature feedback controller 514 of PTAC system 500 dynamically adjusts the corresponding power limits below these maximums. In other words, PTAC system 500 uses the maximum processor and/or platform/device power limits as a governor on the actuated power limit outputs. Typically, PTAC system 500 would rarely, if ever, set the actuated power limit outputs to these maximum processor and/or platform/device power limits.

At step 704, the processor determines the fan speed limit. The processor can receive the fan speed limit from a user via a user interface. Additionally and/or alternatively, the processor can determine the fan speed limit based on various characteristics of computing system 100. Additionally and/or alternatively, the processor can retrieve preset values for the fan speed limit from a memory included in computing system 100. The fan speed limit can be determined based on the environment where computing system 100 is located. If computing system 100 is located in a quiet environment, such as a residential home, a business office, and/or the like, then a low acoustic noise from computing system 100 may be desirable. Accordingly, the processor can set the fan speed limit to a relatively low limit. If computing system 100 is located in a noisy environment, such as a game room, an industrial workspace, and/or the like, then a high acoustic noise from computing system 100 may be acceptable. Accordingly, the processor can set the fan speed limit to a relatively high limit. The processor routes the determined fan speed limit to a fan controller, such as platform fan controller 526 of PTAC system 500, to be applied as a cap or maximum fan speed for one or more fans included in computing system 100.

At step 706, the processor determines the case temperature target. The processor can receive the case temperature target from a user via a user interface. Additionally and/or alternatively, the processor can determine the case temperature target based on various characteristics of computing system 100. Additionally and/or alternatively, the processor can retrieve preset values for the case temperature target from a memory included in computing system 100. The processor can set the case temperature target based on the surface upon which computing system 100 is placed. If computing system 100 is placed directly on the lap of a user, then a low temperature for computing system 100 may be desirable to avoid discomfort to the user. Accordingly, the processor can set the case temperature target to a relatively low limit. If computing system 100 is placed on a temperature resistant surface, such as a desktop, a countertop, and/or the like, then a high temperature for computing system 100 may be acceptable. Accordingly, the processor can set the case temperature target to a relatively high limit.

At step 708, the processor measures the current case temperature. In so doing, the processor receives signals from one or more of CPU temperature sensor 520, GPU temperature sensor 522, case temperature sensor 510, and/or other temperature sensors 534, in any combination, to determine various temperatures within computing system 100. The processor receives one or more signals from a CPU temperature sensor 520, a GPU temperature sensor 522, a case temperature sensor 510, and/or other temperature sensors 534, in any combination. These temperature sensors can measure a junction temperature and/or other device temperature on the surface of an integrated circuit, a package temperature of an assembly that contains integrated circuit, an ambient temperature of the environment within computing system 100, and/or the like.

Proxy temperatures for the case temperature, such as the temperatures from CPU temperature sensor 520, GPU temperature sensor 522, and/or other temperature sensors 534 from can be less accurate than a direct measurement of the enclosure, as measured by case temperature sensor 510. To account for such reduced accuracy, the processor can apply a guard band to artificially increase the proxy temperature(s) determined from temperatures measured by CPU temperature sensor 520, GPU temperature sensor 522, and/or other temperature sensors 534. The processor can combine one or more of the temperatures from case temperature sensor 510 and/or corrected temperature(s) from one or more of CPU temperature sensor 520, GPU temperature sensor 522, and/or other temperature sensors 534 to determine a composite temperature for the enclosure of computing system 100.

At step 710, the processor determines whether the difference between the current case temperature and the case temperature target exceeds a threshold value. In some embodiments, the processor can make this determination at regular intervals, referred to a controller evaluation interval. If the difference between the current case temperature and the case temperature target does not exceed the threshold value, then the method 700 returns to step 708, described above. In particular, if the difference is zero, or in some small range close to zero (as determined from the threshold value), then the processor leaves the actuated power limit unchanged, and the method returns to step 708 to continue to monitor the current case temperature. If, however, the difference between the current case temperature and the case temperature target exceeds the threshold value, then the method 700 proceeds to step 712, where the processor actuates a change in the power limit for one or more components of computing system 100 in a direction that reduces or eliminates the difference between the current case temperature and the case temperature target. The one or more components can include CPU 102, accelerator processing subsystem 112, and/or other components and regions of computing system 100. More specifically, if the current case temperature is less than the case temperature target, then the processor increases the power limit to one or more components, thereby indirectly causing the case temperature to increase. If the current case temperature is greater than the case temperature target, then the processor decreases the power limit to one or more components, thereby indirectly causing the case temperature to decrease. The method 700 then returns to step 708, described above.

It will be appreciated that the system shown herein is illustrative and that variations and modifications are possible. In particular, the system and techniques described in conjunction with FIGS. 1-7 disclose a particular embodiment of a feedback control system. Additionally or alternatively, the system and techniques described herein can be implemented using any one or more other embodiments of feedback control systems within the scope of the present disclosure. These one or more other embodiments of feedback control systems can exhibit different time domain characteristics and levels of compliance within the scope of the present disclosure.

In sum, the disclosed embodiments include techniques for controlling temperature and fan speed in a computing system. As described herein, conventional computing systems present the user with a very limited set of three or four curated perfmode presets, which can impose substantial trade-offs in performance, acoustic noise, and/or casetemp that the user may find to be unacceptable. By contrast, the disclosed techniques allow the user to precisely position the operation of the computing system anywhere in the two-dimensional space (two-space) of fan speed (acoustic noise) versus casetemp that suits the preference of the user. As a result, the user can select a perfmode within a wide range of the two-space rather than being restricted to a small number of perfmode presets. The techniques include controls for adjustable fan speed limit based on the selected perfmode and a closed-loop feedback control system for casetemp, with a corresponding adjustable casetemp limit.

The disclosed techniques further provide a closed-loop feedback control system for controlling the casetemp. This closed-loop feedback control system operates in conjunction with the adjustable casetemp limit to determine individual power limits for certain components, such as a CPU power limit, a GPU power limit, and/or the like. The temperature sensors can be placed on various parts of the platform/device, including on the computing system motherboard, to determine more precise measurement of actual casetemp. In some embodiments, one or more component temperatures, such as CPU temperature, GPU temperature, and/or the like, can be used as a proxy for casetemp. Such components may include an internal temperature sensor that can be accessed by the computing system, thereby reducing the need to add temperature sensors to directly measure casetemp. When such casetemp proxies are employed, the computing system can apply a guard-band to the temperature measurement to account for the potential difference and inaccuracy between component temperature and casetemp. This guard-band approach can reduce the cost of adding temperature sensors to the computing system, as balanced against a potential reduction in casetemp measurement accuracy, which can potentially reduce the maximum achievable performance in a given perfmode.

In operation, a processor, such as CPU 102, PPU 202, a PTAC system 500, and/or the like, sets processor and/or platform/device power limits as high as practicable, within power delivery capabilities of computing system 100 and based on a power delivery capability of the computing system. The processor sets a fan speed limit for one or more variable speed fans and/or other cooling devices, based on a desired target acoustic level. The processor sets a casetemp target, based on a desired target case temperature. In operation, the casetemp control system actuates the power source for one or more devices. The casetemp control system sets the power level below the absolute power limits of the one or more devices. These absolute power limits are set in accordance with the power delivery capabilities. The fan speed is set independently by the fan controller as a function of the corresponding junction temperature of the one or more devices. In some embodiments, the power limit of the one or more devices is sufficiently high such that the junction temperature can rise to a temperature that would otherwise cause the controller to set the fan speeds to exceed the fan speed limit. By contrast, with the disclosed techniques, the fan speed is held constant at the fan speed limit, and not allowed to exceed the fan speed limit, resulting in the desired acoustic level. The casetemp control system adjusts the power of the one or more devices to yield maximum performance, subject to the casetemp limit and/or target, while the fan speed is expected to remain constant at the target fan speed limit.

Via these steps, the processor can maintain the operation of computing system 100 across a multiplicity of perfmodes that can be defined across the entire two- space of acoustics and casetemp, rather than being limited to a small number of preset perfmodes. This two-space can be defined by the relationship between fan speed in revolutions per minute (RPM) and case temperature in degrees Celsius (° C.). Stated another way, the controller can maintain the operation of computing system 100 in all four quadrants of the two-space, namely: (1) a quadrant representing warm and loud operation; (2) a quadrant representing cool and quiet operation; (3) a quadrant representing warm and quiet operation; and/or (4) a quadrant representing cool and loud operation. In addition, by explicitly setting a fan speed limit and casetemp target, the processor included in computing system 100 can provide more precise control of acoustics and casetemp, regardless of fluctuations in ambient temperature or workload-based geographic power distribution. Further, in some embodiments, the processor and the closed-loop feedback control system can adapt to variances resulting from manufacturing tolerance of the components included in the closed-loop feedback control system itself. By contrast, conventional power-limit based systems are not able to adapt to such manufacturing variances.

Further, via the processor included in computing system 100, the user can be afforded independent control of the acoustic and casetemp targets. Depending on the user interface controls provided by computing system 100, a user can select from among a large number of preset perfmodes. As a result, the user can control the perfmode, and, by extension, the performance, fan speed, and casetemp, with as much precision as the user interface software executing on computing system 100 is configured to provide.

As a result, rather than being restricted to a small number of preset perfmodes, the user can customize operating conditions with respect to performance, acoustics, and casetemp. In addition, the computing system can select a steeper fan table curve in the fan speed (acoustic noise) versus casetemp two-space, resulting in access to a greater portion of the cool and noisy operating space, while still maintaining operation at or below the selected fan speed limit and/or casetemp target.

At least one technical advantage of the disclosed techniques relative to the prior art is that, with the disclosed techniques, the computing system is not restricted to a very limited set of perfmodes. Instead, the user interface executing on the computing system can provide input controls to allow the user to fully customize the operation of computing system by trading among performance, acoustics, and casetemp, depending on the needs of the user. In addition, in some embodiments, the fan speed limit can be violated if the current case temperature (casetemp) exceeds, or is substantially close to, a threshold temperature, such as a critical temperature and/or an unsafe temperature, thereby reducing the likelihood of overheating.

Another technical advantage of the disclosed techniques is that, with the disclosed techniques, the computing system includes an adjustable fan speed limit and a closed-loop feedback casetemp controller with a corresponding adjustable casetemp limit for more precise control of actual casetemp. With a more precise control of actual casetemp, the computing system can operate with higher performance in a given perfmode, relative to conventional techniques. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling temperature and fan speed in a computing system, the method comprising:
determining a power limit based on a power delivery capability of the computing system;
determining a first fan speed limit based on a target acoustic level;
determining a first temperature target based on a target case temperature;
identifying a first region within a two-dimensional space of fan speed versus case temperature based on at least one of the power limit, the first fan speed limit, or the first temperature target; and
setting a first operational performance mode of the computing system that corresponds to the first region within the two-dimensional space.

2. The computer-implemented method of claim 1, wherein the power limit comprises at least one of a system power limit, a processor power limit, or a device power limit.

3. The computer-implemented method of claim 1, wherein setting the first operational performance mode is further based on a case temperature of an enclosure of the computing system.

4. The computer-implemented method of claim 3, wherein a temperature sensor measures the case temperature.

5. The computer-implemented method of claim 3, wherein a temperature sensor measures a device temperature of a component of the computing system, and further comprising determining the case temperature by applying a function to the device temperature.

6. The computer-implemented method of claim 1, wherein setting the first operational performance mode comprises:
determining that a first current case temperature of an enclosure of the computing system exceeds a threshold temperature that is substantially close to the first temperature target; and
decreasing a first processing power limit for one or more processors included in the computing system.

7. The computer-implemented method of claim 6, wherein setting the first operational performance mode comprises:
subsequent to decreasing the first processing power limit, determining that a second current case temperature of the enclosure of the computing system does not exceed the threshold temperature; and
increasing the first processing power limit for the one or more processors included in the computing system.

8. The computer-implemented method of claim 1, further comprising:
determining a second fan speed limit that is different from the first fan speed limit;
identifying a second region within the two-dimensional space of fan speed versus case temperature based on at least one of the power limit, the second fan speed limit, or the first temperature target; and
setting a second operational performance mode of the computing system that corresponds to the second region within the two-dimensional space.

9. The computer-implemented method of claim 1, further comprising:
determining a second temperature target that is different from the first temperature target;
identifying a second region within the two-dimensional space of fan speed versus case temperature based on at least one of the power limit, the first fan speed limit, or the second temperature target; and
setting a second operational performance mode of the computing system that corresponds to the second region within the two-dimensional space.

10. A computing system comprising:
a first processor that executes a software application;
a variable speed cooling device;
a temperature sensor; and
a controller that:
determines a power limit based on a power delivery capability of the computing system;
determines a first fan speed limit based on a target acoustic level;
determines a first temperature target based on a target case temperature;
identifies a first region within a two-dimensional space of fan speed versus case temperature based on at least one of the power limit, the first fan speed limit, or the first temperature target; and
sets a first operational performance mode of the computing system that corresponds to the first region within the two-dimensional space.

11. The computing system of claim 10, wherein setting the first operational performance mode is further based on a case temperature of an enclosure of the computing system.

12. The computing system of claim 11, wherein a temperature sensor measures the case temperature.

13. The computing system of claim 11, wherein a temperature sensor measures a device temperature of a component of the computing system, and further comprising determining the case temperature by applying a function to the device temperature.

14. The computing system of claim 10, wherein, to set the first operational performance mode, the controller further:
determines that a first current case temperature of an enclosure of the computing system exceeds a threshold temperature that is substantially close to the first temperature target; and
decreases a first processing power limit for the first processor.

15. The computing system of claim 14, wherein, to set the first operational performance mode, the controller further:
subsequent to decreasing the first processing power limit, determines that a second current case temperature of the enclosure of the computing system does not exceed the threshold temperature; and
increases the first processing power limit for the first processor.

16. The computing system of claim 10, wherein the controller further:
determines a second fan speed limit that is different from the first fan speed limit;
identifies a second region within the two-dimensional space of fan speed versus case temperature based on at least one of the power limit, the second fan speed limit, or the first temperature target; and
sets a second operational performance mode of the computing system that corresponds to the second region within the two-dimensional space.

17. The computing system of claim 10, wherein the controller further:
determines a second temperature target that is different from the first temperature target;
identifies a second region within the two-dimensional space of fan speed versus case temperature based on at least one of the power limit, the first fan speed limit, or the second temperature target; and
sets a second operational performance mode of the computing system that corresponds to the second region within the two-dimensional space.

18. One or more non-transitory computer readable media storing program instructions that, when executed by one or more processors, cause the one or more processors to perform steps of:
determining a power limit based on a power delivery capability of a computing system that includes the one or more processors;
determining a first fan speed limit based on a target acoustic level;
determining a first temperature target based on a target case temperature;
identifying a first region within a two-dimensional space of fan speed versus case temperature based on at least one of the power limit, the first fan speed limit, or the first temperature target; and
setting a first operational performance mode of the computing system that corresponds to the first region within the two-dimensional space.

19. The one or more non-transitory computer readable media of claim 18, wherein the program instructions, when executed by the one or more processors, cause the one or more processors to further perform steps of:
determining a second fan speed limit that is different from the first fan speed limit;
identifying a second region within the two-dimensional space of fan speed versus case temperature based on at least one of the power limit, the second fan speed limit, or the first temperature target; and
setting a second operational performance mode of the computing system that corresponds to the second region within the two-dimensional space.

20. The one or more non-transitory computer readable media of claim 18, wherein the program instructions, when executed by the one or more processors, cause the one or more processors to further perform steps of:
determining a second temperature target that is different from the first temperature target;
identifying a second region within the two-dimensional space of fan speed versus case temperature based on at least one of the power limit, the first fan speed limit, or the second temperature target; and
setting a second operational performance mode of the computing system that corresponds to the second region within the two-dimensional space.
